(19) United States
(12) Patent Application Publication
(10) Pub. No.: US 2020/0177879 A1
(43) Pub. Date: Jun. 4, 2020

(54) IMAGE TRANSMISSION AND RECEPTION SYSTEM, SERVER, AND IMAGING APPARATUS

(71) Applicant: SONY SEMICONDUCTOR SOLUTIONS CORPORATION, KANAGAWA (JP)

(72) Inventor: AKITOSHI ISSHIKI, CHIBA (JP)

(21) Appl. No.: 16/615,161

(22) PCT Filed: Apr. 10, 2018
(86) PCT No.: PCT/JP2018/014996

§ 371 Date: Nov. 20, 2019

(30) Foreign Application Priority Data
Jun. 29, 2017 (JP) 2017-126843

(51) Int. Cl. H04N 19/122; H04N 19/182; H04N 19/186

(52) U.S. Cl. CPC H04N 19/122; H04N 19/186; H04N 19/182

(57) ABSTRACT

A load on restoring processing of a sampling signal by compressive sensing is reduced. In an image transmission and reception system, an imaging apparatus and a server are connected with each other via a network. The imaging apparatus randomly selects part of pixels from a plurality of pixels corresponding to light from a subject and photoelectrically converts the selected pixels, thereby transmitting the photoelectrically converted pixels as compressed image signals in a time sequence. The server receives the compressed image signals from the imaging apparatus via the network and restores the received compressed image signals on the basis of a sampling matrix that specifies the selection in the imaging apparatus.

### TECHNICAL FIELD

The present invention relates to an image transmission and reception system. Specifically, the present invention relates to an image transmission and reception system, a server, and an imaging apparatus for transmitting and receiving an image to which compressive sensing is applied.

### BACKGROUND ART

Conventionally, an image sensor based on compressed sensing (CS: Compressive Sensing) has been known. This compressive sensing is a technology in which a small amount of data is randomly sampled from an observation signal and, from this sampling signal and a random sampling matrix, an original observation signal is restored. Here, the sample matrix has sampling pattern information indicative which of the pixels has been sampled. If the observation signal is a signal having sparsity, then the number of zero elements increases as a characteristic to provide the redundant number of dimensions, thereby allowing the restoration even with a small number of samples. As a technology using this compressive sensing, an image processing apparatus for processing an image signal outputted from an image sensor having a color filter with each color randomly arranged on a front side thereof, for example, has been proposed (refer to PTL 1, for example).

### CITATION LIST

### Patent Literature

### [PTL 1]

Japanese Patent Laid-open No. 2016-034055

### SUMMARY

### Technical Problems

In the conventional technology mentioned above, the use of compressive sensing allows the restoration of an original observation signal from a small number of sample data. However, if such restoration processing based on compressive sensing is executed on a terminal of each user, there are problems that preparing a restoration processing program for each terminal is needed and a load in association with the restoration processing is increased.

The present technology has been made in consideration of the situation described above, and it is therefore an object of the present technology to reduce a load on restoring processing of a sampling signal by use of compressive sensing.

### Solution to Problems

The present technology has been intended to solve the problems mentioned above. According to one aspect of the present technology, there is provided an image transmission and reception system including: an imaging apparatus photoelectrically converting part of pixels randomly selected from a plurality of pixels corresponding to light from a subject and transmitting the photoelectrically converted pixels as compressed image signals in a time sequence; and a server receiving the compressed image signals via a network and restoring the compressed image signal on the basis of a sampling matrix for specifying the selection. This configuration brings about an effect that the compressed image signals based on compressive sensing are restored to an original image in the server.

Further, in this first aspect, the server may include a sampling matrix memory storing the sampling matrix. This configuration brings about an effect that an image is restored on the basis of the sampling matrix stored in the sampling matrix memory.

Still further, in this first aspect, before executing the restoration, the server may receive the sampling matrix from the imaging apparatus via the network and store the received sampling matrix into the sampling matrix memory. This configuration brings about an effect that an image is restored on the basis of the sampling matrix received via the network.

Yet further, in this first aspect, the imaging apparatus may detect an area in which luminance has changed as time passes with respect to the compressed image signals and transmit the area in which the change of the luminance of the compressed image signals has been detected to the server as an area signal. This configuration brings about an effect that the server is made to restore the compressed image signals of the area in which the change of the luminance has been detected.

Also, In this first aspect, the server may include a reference image memory storing a reference image serving as a background of an image of the area signal, an image combining portion combining an image of the area signal transmitted from the imaging apparatus with the reference image to generate a combined image, an event sensing processing portion sensing occurrence of an event in the combined image, and a restored image memory storing an image of the combined image after executing the restoration in accordance with a result of the sensing of the event. This configuration brings about an effect that the image after executing the restoration is stored in accordance with the result of the sensing of the event. In this case, the above-mentioned event sensing processing portion may sense occurrence of the event by referring to the image of the combined image after executing the restoration or sense occurrence of the event by referring to an image of the combined image before executing the restoration.

Further, in this first aspect, the server may store the sampling matrix relating with a predetermined identifier in the sampling matrix memory, and upon reception of an image request along with the identifier from a terminal via the network, restore the compressed image signals on the basis of the sampling matrix stored in the sampling matrix memory as related with the received identifier to transmit the restored compressed image signals to the terminal. This configuration brings about an effect that an image is restored on the basis of the sampling matrix related with the identifier received along with the image request. In this case, the server can execute transmission to the terminal only when the restoration is successful.

Still further, in the second aspect of the present technology, there is provided a server including: a receiving portion receiving, via a network, compressed image signals photoelectrically converted for part of pixels randomly selected from a plurality of pixels corresponding to light from a subject in accordance with a predetermined sampling matrix; and a restoring portion restoring the compressed image signals on the basis of the sampling matrix. This configuration brings about an effect that the compressed image signals received via the network are restored.

Yet further, in the third aspect of the present technology, there is provided an imaging apparatus including: an imaging portion photoelectrically converting part of pixels randomly selected from a plurality of pixels corresponding to light from a subject to output photoelectrically converted pixels as compressed image signals in a time sequence; a change detecting portion detecting an area in which luminance has changed in accordance with lapse of time with respect to the compressed image signals; and a transmitting portion transmitting, to a server, the area in which the change of the luminance of the compressed image signals has been detected. This configuration brings about an effect that a server is requested for restoring the compressed image signals of an area in which the change of the luminance has been detected.

### Advantageous Effect of Invention

According to the present technology, excellent effects of reducing a load on restoring processing of a sampling signal by use of compressive sensing can be achieved. It should be noted that the effect described herein is not limited thereto and therefore, any one of the effects described in the present disclosure may be applicable.

### BRIEF DESCRIPTION OF DRAWINGS

FIG. 1 is a diagram illustrating an example of an overall configuration of an image transmission and reception system in a first embodiment of the present technology.

FIG. 2 is a diagram illustrating one example of a functional configuration of an imaging apparatus 100 in the first embodiment of the present technology.

FIG. 3 is a diagram illustrating one example of a functional configuration of a server 200 in the first embodiment of the present technology.

FIG. 4 is a diagram illustrating an example of an aspect of compressive sensing in the embodiment of the present technology.

FIG. 5 is a diagram illustrating an example of a relation between a reference image and a changed area image in the embodiment of the present technology.

FIG. 6 is a flowchart indicative of an example of a processing procedure of the imaging apparatus 100 in the embodiment of the present technology.

FIG. 7 is a flowchart indicative of an example of a processing procedure of the server 200 in the embodiment of the present technology.

FIG. 8 is a flowchart indicative of an example of a processing procedure of image storing processing of the server 200 in the first embodiment of the present technology.

FIG. 9 is a diagram illustrating one example of a functional configuration of the server 200 in a modification of the first embodiment of the present technology.

FIG. 10 is a flowchart indicative of an example of a processing procedure of image storing processing of the server 200 in the modification to the first embodiment of the present technology.

FIG. 11 is a diagram illustrating an example of an overall configuration of an image transmitting and receiving apparatus in a second embodiment of the present technology.

FIG. 12 is a diagram illustrating one example of a functional configuration of a server 200 in the second embodiment of the present technology.

FIG. 13 is a flowchart indicative of a processing procedure of image combining processing of the server 200 in the second embodiment of the present technology.

FIG. 14 is a flowchart indicative of an example of a processing procedure of image requesting processing of the server 200 in the second embodiment of the present technology.

FIG. 15 is a diagram illustrating one example of a functional configuration of a server 200 in a third embodiment of the present technology.

FIG. 16 is a flowchart indicative of an example of a processing procedure to be executed at the time of receiving an image of the server 200 in the third embodiment of the present technology.

FIG. 17 is a diagram illustrating an example of a schematic configuration of an IoT system 9000 to which the technology according to an embodiment of the present disclosure is applicable.

### DESCRIPTION OF EMBODIMENTS

In the following, a description will be given regarding modes of carrying out the present technology (hereafter referred to as embodiments). The description will be given in the following sequence.

1. First embodiment (an example in which an image area with luminance has changed is transmitted to a server)

2. Second embodiment (an example in which a server is restored by use of a sampling matrix related with an identifier)

3. Third embodiment (an example in which a server restores each image before combining)

4. Application examples

### 1. FIRST EMBODIMENT

<Image Transmission and Reception System>

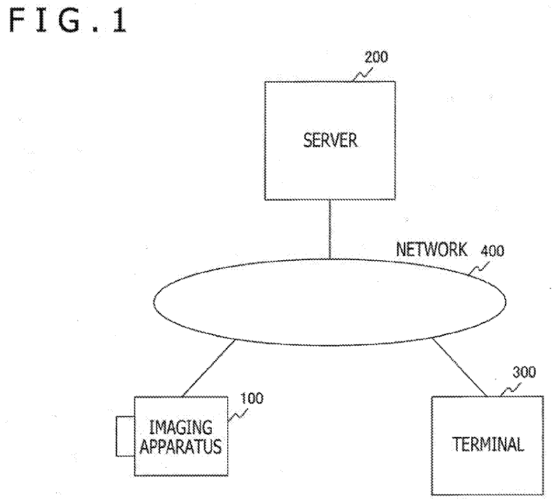

FIG. 1 is a diagram illustrating an example of an overall configuration of an image transmission and reception system in a first embodiment of the present technology. This image transmission and reception system has an imaging apparatus 100, a server 200, a terminal 300, and a network 400. In the image transmission and reception system 100, the server 200 and the terminal 300 are interconnected through the network 400.

The imaging apparatus 100 is a camera for picking up an image of a subject. The imaging apparatus 100 photoelectrically converts pixels randomly selected and generates compressed image signals by compressive sensing. This compressed image signals configure frames arranged in a time sequence manner. In other words, this imaging apparatus 100 outputs moving image data compressed by compressive sensing. This moving data is transmitted to the server 200 via the network 400.

The server 200 restores the compressed signal with respect to the moving data received from the imaging apparatus 100 via the network 400. This server 200 stores a compressed image signal before restoration or an image signal after restoration and transmits the image signal after restoration in response to a request from the terminal 300. In addition, in order to provide services to the terminal 300 via the network 400, this server 200 has an interface for a console and an interface (API: Application Programming Interface) between applications.

The terminal 300 is a terminal to be used by a user. The user requests the server 200 via the network 400 for transmission of an image signal. This allows the user to receive an image signal restored in the server 200.

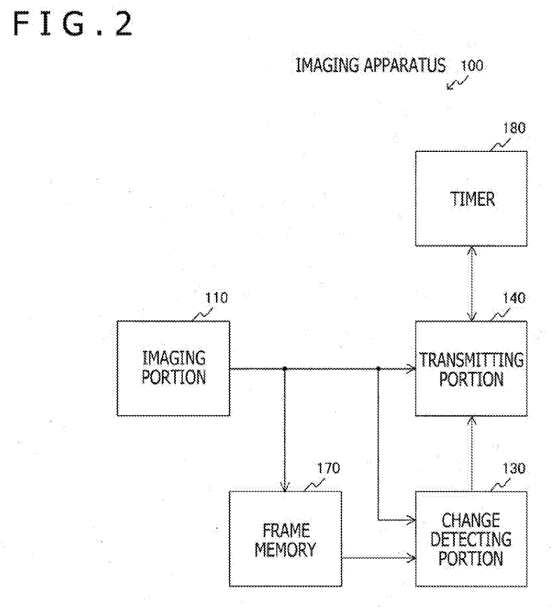

FIG. 2 is a diagram illustrating one example of a functional configuration of the imaging apparatus 100 in the first embodiment of the present technology. In this first embodiment, the imaging apparatus 100 is assumed to be used for fixed-point observation, for example, and transmit an image in an area where a change occurs to the server 200. This imaging apparatus 100 includes an imaging portion 110, a change detecting portion 130, a transmitting portion 140, a frame memory 170, and a timer 180.

The imaging portion 110 is an image sensor that photoelectrically converts part of pixels randomly selected from a plurality of pixels corresponding to light from the subject, thereby generating compressed image signals. This imaging portion 110 has a function of compressive sensing. In other words, by assuming the plurality of pixels corresponding to light from a subject, only part of pixels randomly selected from the plurality of pixels, rather than all of the pixels, are photoelectrically converted. In the selection of this case, sampling pattern information indicative of which of the pixels has been sampled is set as a sampling matrix. This sampling matrix is used for restoration in the server 200. Therefore, this sampling matrix needs to be stored in the server 200 before restoration or transmitted from the imaging apparatus 100 to the server 200 via the network 400 with a given timing.

The frame memory 170 is a memory that stores compressed image signals generated by the imaging portion 110 as frames arranged in a time sequence. Each frame to be stored in this frame memory 170 is an image signal compressed by compressive sensing and not all the pixels corresponding to the light from the subject. Therefore, each frame to be stored can be reduced in capacity than a total image signal.

The change detecting portion 130 makes comparison between a frame stored in the frame memory 170 and a compressed image signal generated by the imaging portion 110 so as to detect an area in which the luminance has changed with time. Upon detecting a change, this change detecting portion 130 supplies the information related with the area in which the change of the luminance has been detected to the transmitting portion 140.

The transmitting portion 140 transmits the compressed image signal generated by the imaging portion 110 to the server 200 via the network 400. Every time a certain time has passed, this transmitting portion 140 transmits the entirety of the compressed image signal generated by the imaging portion 110 to the server 200 as a reference image. To count the lapse of the certain time, a timer 180 is arranged. Further, upon detection of a change by the change detecting portion 130, this transmitting portion 140 transmits a compressed image signal in an area in which this change has been detected and the coordinates of this area to the server 200. Consequently, the server 200 embeds the compressed image signal of that area into the reference image, thereby updating the reference image. More specifically, this reference image serves as the background of an image of the compressed image signal of the area in which a change has been detected.

The timer 180 includes a timer for counting lapse of a certain time for the transmitting portion 140 to transmit a compressed image signal.

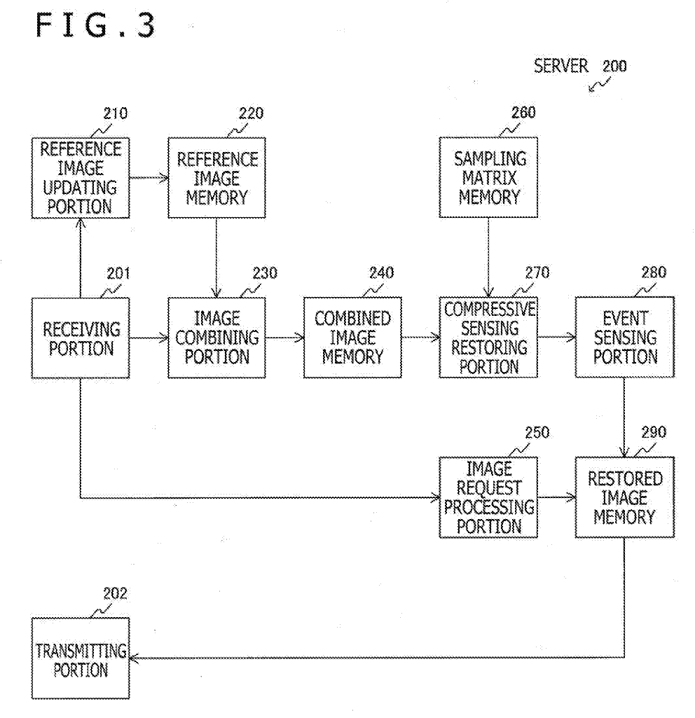

FIG. 3 is a diagram illustrating one example of a functional configuration of the server 200 in the first embodiment of the present technology. This server 200 includes a receiving portion 201, a reference image updating portion 210, a reference image memory 220, an image combining portion 230, a combined image memory 240, a sampling matrix memory 260, a compressive sensing restoring portion 270, and an event sensing portion 280. Also, the server 200 includes an image request processing portion 250, a restored image memory 290, and a transmitting portion 202.

The receiving portion 201 receives the compressed image signal transmitted from the imaging apparatus 100. The transmitting portion 202 transmits the restored image signal to the terminal 300.

The reference image memory 220 includes a memory for storing the entirety of the compressed image signal transmitted from the imaging apparatus 100 as a reference image.

The reference image updating portion 210, in a case in which the compressed image signal received by the receiving portion 201 is the entirety of the image, updates the reference image memory 220 with this compressed image signal as a new reference image.

The image combining portion 230, in a case in which the compressed image signal received by the receiving portion 201 corresponds to an area that is part of a reference signal to be stored in the reference image memory 220, combines the compressed image signal with the reference image to be stored in the reference image memory 220, thereby generating a combined image indicative of the entire image.

The combined image memory 240 includes a memory for storing a combined image combined by the image combining portion 230.

The sampling matrix memory 260 includes a memory for storing a sampling matrix to be used in restoring compressive sensing. A sampling matrix may only be prepared until restoration or may be stored in the sampling matrix memory 260 in advance, or a sampling matrix transmitted from the imaging apparatus 100 to the server 200 with a given timing may be stored.

The compressive sensing restoring portion 270 restores a compressively sensed combined image stored in the combined image memory 240 to an original image signal by use of a sampling matrix stored in the sampling matrix memory 260. It should be noted that the compressive sensing restoring portion 270 is one example of the restoring portion recited in the scope of claims.

The event sensing portion 280 executes event sensing processing for sensing occurrence of an event in the image signal restored by the compressive sensing restoring portion 270. Here, event sensing processing is the processing for monitoring an image signal and sensing an object such as a person or a car. In this event sensing processing, an image analysis technology based on feature quantity is used, for example. When occurrence of an event is sensed as a result of this event sensing processing, the image signal restored by the compressive sensing restoring portion 270 is stored in the restored image memory 290.

The restored image memory 290 is a memory for storing the image signal restored by the compressive sensing restoring portion 270 as a restored image. When the occurrence of an event is sensed by the event sensing portion 280, this restored image memory 290 stores the image signal restored by the compressive sensing restoring portion 270. Therefore, since a restored image is stored only when it is necessary on the basis of a result of event sensing processing, no excess image signal need be stored, thereby saving a storage capacity of the restored image memory 290.

In a case in which a request for an image signal is issued from the terminal 300, the image request processing portion 250 processes this image request. When the receiving portion 201 receives an image request from the terminal 300, the image request processing portion 250 makes the transmitting portion 202 transmit the restored image stored in the restored image memory 290 to the terminal 300. Consequently, the terminal 300 can receive the requested restored image from the server 200.

<Compressive Sensing>

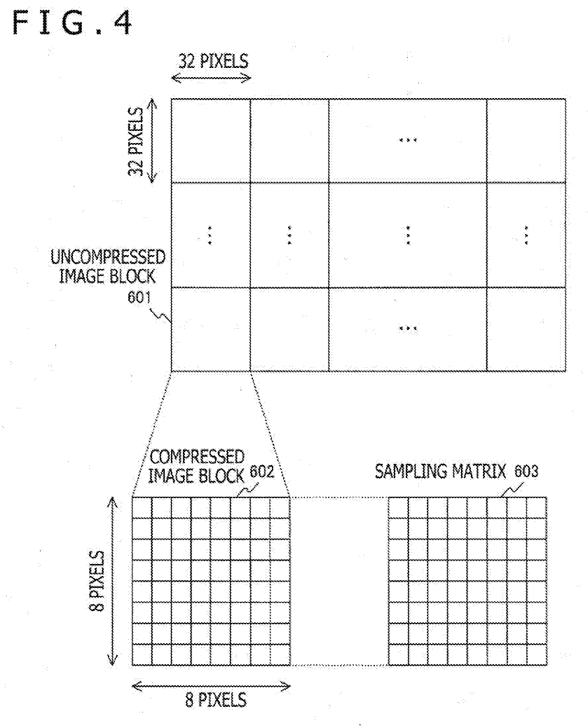

FIG. 4 is a diagram illustrating an example of an aspect of compressive sensing in the embodiment of the present technology. In this case, by way of example, it is assumed that a plurality of pixels corresponding to light from a subject is divided into a plurality of uncompressed image blocks 601, each having vertical 32 pixels×horizontal 32 pixels, for example. Then, in each of the uncompressed image blocks 601, compression is executed by compressive sensing. For example, an image of vertical 8 pixels×horizontal 8 pixels randomly selected from vertical 32 pixels×horizontal 32 pixels serves as a compressed image block 602. In this example, a compression ratio is 16 times as high.

Further, a sampling matrix 603 has sampling pattern information indicative which of the pixels has been sampled. This sampling matrix 603 holds a coordinate position in the original uncompressed image block 601 in accordance with each pixel of the compressed image block 602, for example. Referring to this sampling matrix 603, it is possible to achieve reproduction that a value of each pixel of the compressed image block 602 corresponds to a value of which of the pixels in the original uncompressed image block 601.

In this case, when the image signal corresponding to the light from the subject is assumed to be a vector x, the compressed image signal obtained by compressive sensing be a vector y, and the sampling matrix be A, a relation therebetween can be expressed as the following equation:

y=Ax

Solving the equation mentioned above as simultaneous equations allows acquisition of an original image signal x from a compressed image signal y and a sampling matrix A.

It should be noted that, since the number of pixels (8×8 in the example mentioned above) of compressed image signal y is lower in dimension than the number of pixels (32×32 in the example mentioned above) of image signal x, a solution cannot be uniquely determined in general. In this case, however, such a setting that image signal x is k sparse and the number of non-zero elements is k is used. More specifically, it is known that there are many zero elements as a characteristic of a natural image and, when the number of non-zero elements of the image signal x is smaller than the dimension of the compressed image signal y, for example, applying L1 restoration method (L1 reconstruction method) by use of the sampling matrix A having randomness allows the restoration of the image signal x with some probability. That is, since a natural image is redundant in a direction of a spatial frequency, even if a sampling quantity is thinned out, restoration can be achieved. For such restoration, use of a deep neural network (DNN) of multiple layers, for example, is assumed.

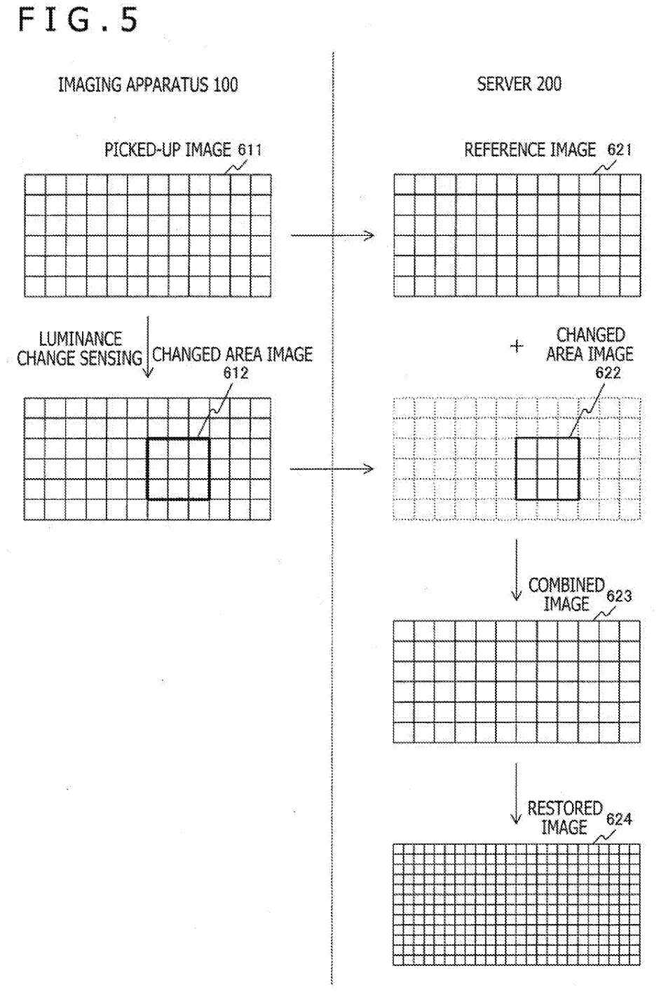

FIG. 5 is a diagram illustrating an example of a relation between a reference image and a changed area image in the embodiment of the present technology.

A picked-up image 611 picked up in the imaging apparatus 100 is transmitted to the server 200 every time a certain time passes. The server 200 stores the received picked-up image 611 into the reference image memory 220 as a reference image 621.

Subsequently, upon sensing of a change in the luminance of the picked-up image 611 in the imaging apparatus 100, a changed area image 612 in the changed area is transmitted to the server 200 along with the coordinates of the changed area image 612. Receiving this image and coordinates, the server 200 embeds a changed area image 622 into the reference image 621 to generate a combined image 623.

In accordance with a result of the event sensing processing, the combined image 623 is restored to a restored image 624 by the compressive sensing restoring portion 270. In response to a request by the terminal 300 for the image, the restored image 624 is transmitted to the terminal 300.

<Operations>

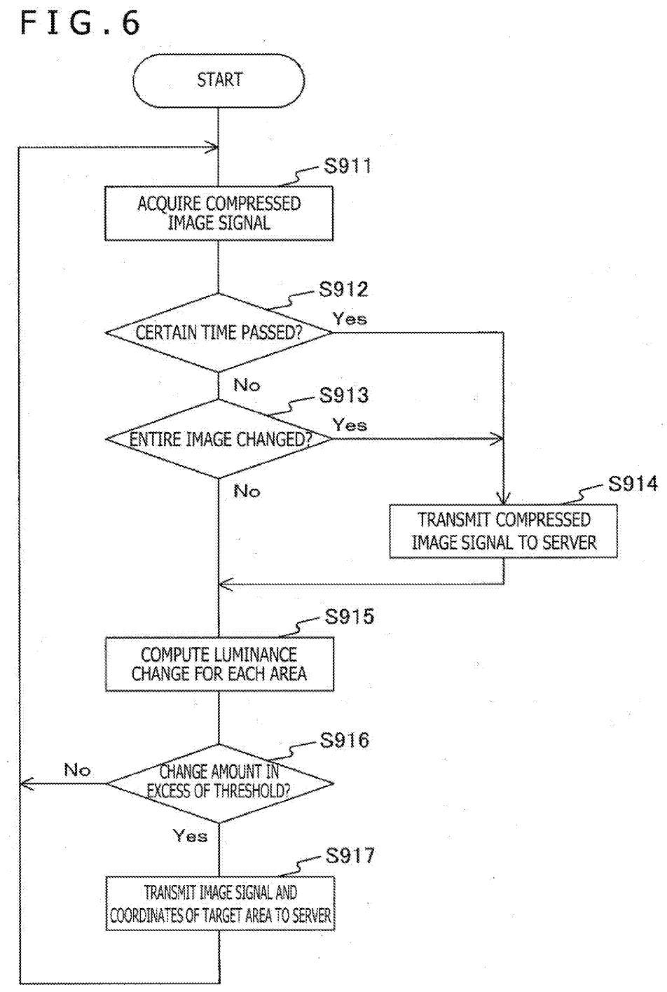

FIG. 6 is a flowchart indicative of an example of a processing procedure of the imaging apparatus 100 in the embodiment of the present technology.

The imaging apparatus 100 photoelectrically converts part of pixels randomly selected from the plurality of pixels corresponding to the light from the subject by the imaging portion 110, and acquires compressed image signals by compressive sampling (step S911).

When lapse of a certain time is counted by the timer 180 (step S912: Yes), the transmitting portion 140 transmits the compressed image signal (step S914). Even if it is before the lapse of a certain time (step S912: No) and in a case in which a change has occurred on the entire image (step S913: Yes), then the transmitting portion 140 transmits the compressed image signal (step S914). It should be noted that, when the entire compressed image signal is transmitted, the timer 180 is reset. Consequently, the counting of a certain time is started anew.

For the picked-up compressed image signal, a change in luminance is computed for each area in the change detecting portion 130 (step S915). In other words, a frame stored in the frame memory 170 is compared with the compressed image signal generated by the imaging portion 110. Consequently, when a quantity of the change exceeds a predetermined threshold value (step S916: Yes), the compressed image signal in that a target area and the coordinates of this area are transmitted from the transmitting portion 140 to the server 200 (step S917). Subsequently, these processing operations are repetitively executed.

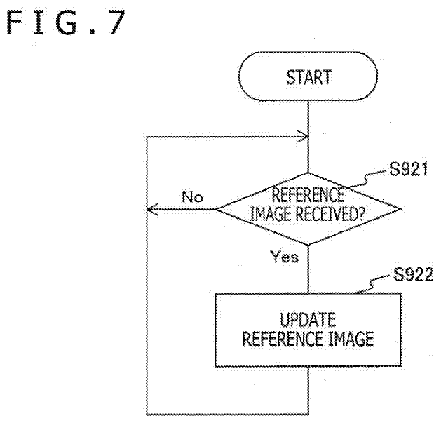

FIG. 7 is a flowchart indicative of an example of a processing procedure of the server 200 in the embodiment of the present technology.

When the receiving portion 201 receives a compressed image signal in the server 200, if the received signal is indicative of the entire compressed image signal (step S921: Yes), then the reference image updating portion 210 updates the reference image memory 220 with this compressed image signal as a reference image (step S922). Accordingly, a latest reference image is stored in the reference image memory 220. Consequently, these processing operations are repetitively executed.

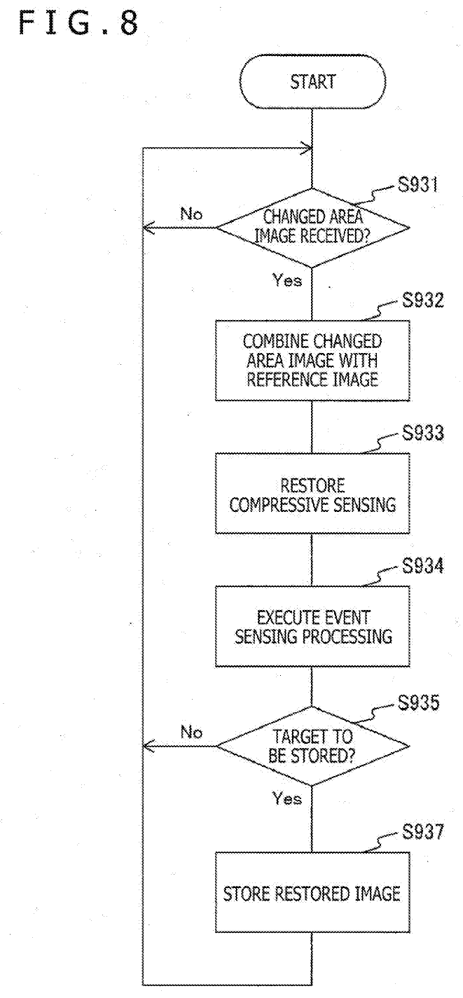

FIG. 8 is a flowchart indicative of an example of a processing procedure of image storing processing of the server 200 in the first embodiment of the present technology.

When the receiving portion 201 receives a compressed image signal in the server 200, if the received signal is indicative of a changed area image (step S931: Yes), the following processing is executed. First, this changed areas image is combined with a reference image stored in the reference image memory 220, thereby generating a combined image (step S932). Next, the compressive sensing restoring portion 270 restores this combined image to a restored image that is the original image signal (step S933).

Then, the event sensing portion 280 executes event sensing processing on the restored image (step S934). In case in which a result of this event sensing processing indicates that this restored image is to be stored (step S935: Yes), then the restored image is stored in the restored image memory 290 (step S937). Subsequently, these processing operations are repetitively executed.

As described above, in the first embodiment of the present technology, when a change in luminance is sensed in the imaging apparatus 100 that executes compressive sensing, a changed area image is transmitted to the server 200. Accordingly, a combined image is generated in the server 200, and the restoration of compressive sensing is executed on this combined image. In a case in which purposes of use of the imaging apparatus 100 that executes compressive sensing are monitoring and fixed-point observation of IoT etc., there are many frames and areas with no change during picking up images, so that the processing can be reduced by this first embodiment.

More specifically, since pieces of data to be transmitted from the imaging apparatus 100 to the server 200 are only a reference image, a changed area image, and coordinates thereof, a transmission data quantity can be decreased. Further, since pieces of data to be stored on the side of the server 200 are only a reference image, a changed area image and coordinates thereof, and a restored image as required, a storage quantity in the server 200 can be decreased. Still further, a quantity of processing on the side of the imaging apparatus 100 is decreased, and accordingly, power consumption can be lowered.

<Modification>

In the first embodiment described above, event sensing processing is executed after the restoration of compressive sensing in the server 200. By contrast, in the present modification, event sensing processing is executed before the restoration of compressive sensing.

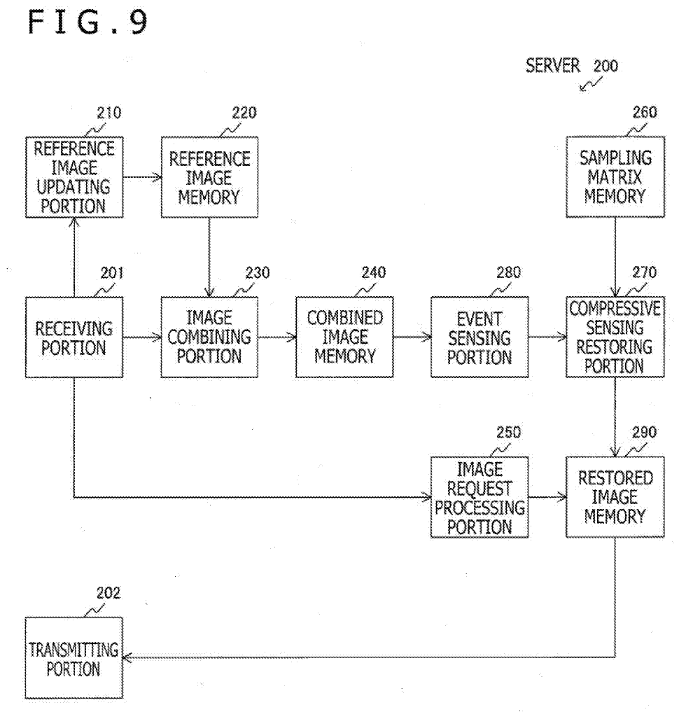

FIG. 9 is a diagram illustrating one example of a functional configuration of the server 200 in a modification of the first embodiment of the present technology. As compared with the first embodiment, in the server 200 according to the modification, the compressive sensing restoring portion 270 is replaced by the event sensing portion 280, thereby providing a configuration in which event sensing processing is executed before the restoration of compressive sensing.

To execute event sensing processing before the restoration of compressive sensing, use of the deep neural network mentioned above is assumed. It is also possible to create a deep neural network for the restoration of compressive sensing and a deep neural network for identifying a restored image, and by making these neural networks learnt and combining them, restoration and recognition can be also executed together as one process.

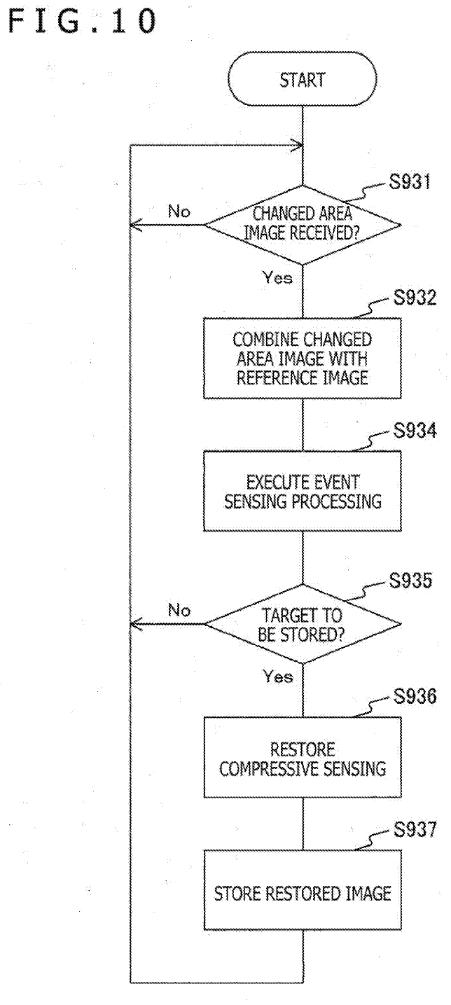

FIG. 10 is a flowchart indicative of an example of a processing procedure of image storing processing of the server 200 in the modification to the first embodiment of the present technology.

When the receiving portion 201 receives a compressed image signal in the server 200, if this signal is a changed area image (step S931: Yes), the following processing is executed. First, as with the first embodiment described above, this changed area image is combined with a reference image stored in the reference image memory 220, thereby generating a combined image (step S932). Next, the event sensing portion 280 executes event sensing processing on the combined image (step S934).

In a case in which a result of this event sensing processing indicates that this combined image is to be restored and stored (step S935: Yes), the compressive sensing restoring portion 270 restores this combined image to the restored image that is the original image signal (step S936). Then, this restored image is stored in the restored image memory 290 (step S937). Subsequently, these processing operations are repetitively executed.

As described above, according to the modification of the first embodiment of the present technology, only a necessary image is restored in accordance with a result of event sensing processing, thereby saving a processing cost required for restoration.

### 2. SECOND EMBODIMENT

<Image Transmission and Reception System>

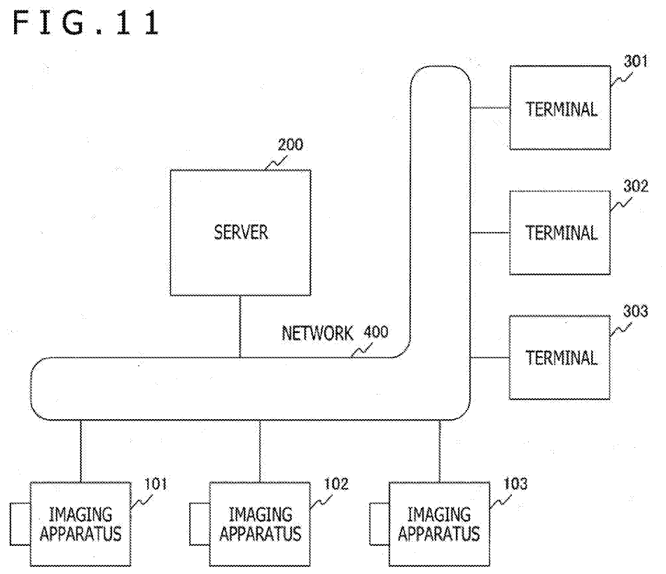

FIG. 11 is a diagram illustrating an example of an overall configuration of an image transmitting and receiving apparatus in a second embodiment of the present technology. This image transmission and reception system includes a plurality of imaging apparatuses 101 through 103, the server 200, a plurality of terminals 301 through 303, and the network 400 which are interconnected via the network 400. More specifically, the second embodiment is different from the first embodiment described above in that the second embodiment presupposes the arrangement of the plurality of imaging apparatuses and the plurality of terminals. In this second embodiment, it is assumed that the server 200 is shared by a plurality of users, thereby enhancing a security between users. It should be noted that, since the basic configurations of the imaging apparatuses 101 through 103 are generally similar to the imaging apparatus 100 in the first embodiment described above, a detailed description will be omitted.

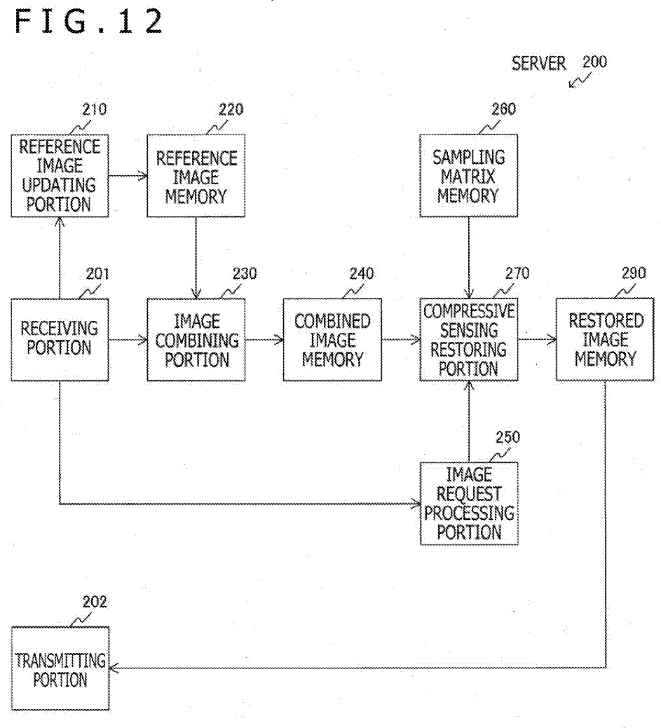

FIG. 12 is a diagram illustrating one example of a functional configuration of a server 200 in the second embodiment of the present technology. This server 200 includes a receiving portion 201, a reference image updating portion 210, a reference image memory 220, an image combining portion 230, a combined image memory 240, a sampling matrix memory 260, and a compressive sensing restoring portion 270. In addition, this server 200 includes an image request processing portion 250, a restored image memory 290, and a transmitting portion 202. In other words, the second embodiment is different from the first embodiment described above in that the second embodiment does not include the event sensing portion 280. In the first embodiment described above, a restored image is stored in the restored image memory 290 with a result of event sensing used as a trigger; in this second embodiment, however, restoration is executed by use of an image request from any of the terminals 301 through 303 as a trigger.

The image transmission and reception system in the second embodiment assumes that compressive sensing be executed on the basis of a sampling matrix that is different for each user. Hence, a sampling matrix is stored in the sampling matrix memory 260 as related with the identifier of each user. The sampling matrices that are different for each user may be stored in the sampling matrix memory 260 of the server 200 before restoration or the sampling matrices transmitted from the imaging apparatuses 101 through 103 to the server 200 may be stored at a given timing.

An image request from the terminals 301 through 303 includes the identifier of each user. Using the identifier of each user included in an image request, the server 200 indexes the sampling matrix memory 260 and executes the restoration in the compressive sensing restoring portion 270 by use of a sampling matrix related with this identifier. Therefore, in a case in which a sampling matrix other than a sampling matrix to be assumed is used, restoration cannot be executed correctly, thereby failing in transmission of the image.

For example, it is assumed that a user A owns the imaging apparatus 101 and the terminal 301, a user B owns the imaging apparatus 102 and the terminal 302, a user C owns the imaging apparatus 103 and the terminal 303.

A sampling matrix used for the compressive sensing in the imaging apparatus 101 is related with the identifier of the user A and stored in the sampling matrix memory 260. When the user A transmits an image request of the user A from the terminal 301 to the server 200, the identifier of the user A is transmitted together. Consequently, the server 200 can acquire, from the sampling matrix memory 260, the sampling matrix stored as related with the identifier of the user A for correct restoration.

Meanwhile, even if the user B attempts to request the user A for an image, the identifier of the user B is included in this image request, so that the server 200 attempts restoration by use of a sampling matrix related with the identifier of the user B. In this case, since the sampling matrix is not proper, the restoration of compressive sensing fails. Thus, the image of the user A managed by the server 200 is not viewed by other users.

It should be noted that, in this example, a mode in which one imaging apparatus and one terminal are allocated to each user has been described; however, each user may own a plurality of imaging apparatuses and terminals. For example, the user A may own the imaging apparatuses 101 and 102 so as to execute compressive sensing by the same sampling matrix on both the imaging apparatuses. In this case, the user A transmits an image request including the identifier of the user A from the terminal 301, so that an image picked up by one of the imaging apparatuses 101 and 102 can be viewed.

Further, in this example, an example in which an identifier is allocated to each user; however, various other modes are possible for identifier allocation standards. For example, different identifiers may also be allocated to monitor camera installing locations to thereby allow only a user authorized for each of these locations to view images.

<Operations>

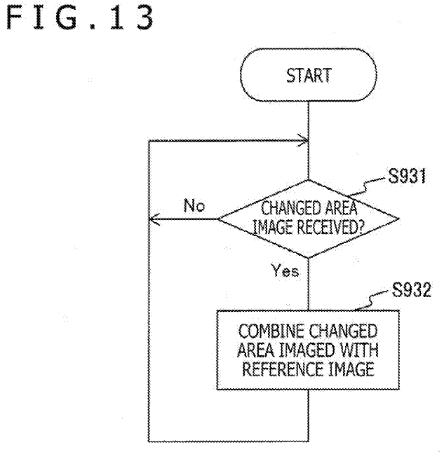

FIG. 13 is a flowchart indicative of a processing procedure of image combining processing of the server 200 in the second embodiment of the present technology.

When the receiving portion 201 receives a compressed image signal in the server 200, if this image is a changed area image (step S931: Yes), then this changed area image is liked with a reference image stored in the reference image memory 220 (step S932) so as to generate a combined image (step S932). Subsequently, these processing operations are repetitively executed.

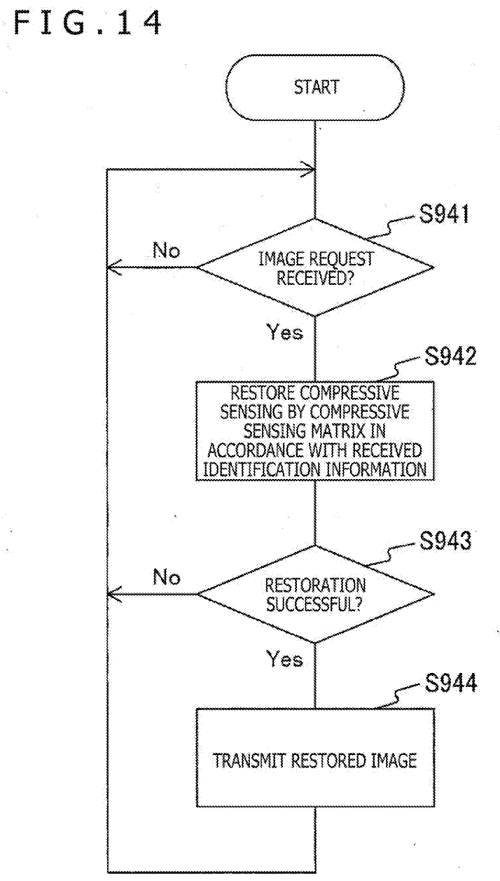

FIG. 14 is a flowchart indicative of an example of a processing procedure of image requesting processing of the server 200 in the second embodiment of the present technology. These processing operations are executed under control of the image request processing portion 250.

When the receiving portion 201 receives an image request from the terminals 301 through 303 in the server 200 (step S941: Yes), the restoration of compressive sensing is executed by use of a sampling matrix related with the identifier included in the image request (step S942).

When the restoration of compressive sensing by the compressive sensing restoring portion 270 is successful (step S943: Yes), the restored image is transmitted from the transmitting portion 202 to the requesting terminals 301 through 303 (step S944). Conversely, when the restoration of the compressive sensing by the compressive sensing restoring portion 270 is unsuccessful (step S943: No), then the restored image is not transmitted.

As described above, according to the second embodiment of the present technology, setting different sampling matrices for each identifier prevents transmission of an image for an unauthorized image request, thereby enhancing security.

More specifically, changing the sampling matrices for each of customers or installation places of the imaging apparatuses 101 through 103 can prevent the viewing and interception of other image data. Further, since compressive sensing is executed on some randomly selected pixels in the imaging apparatuses 101 through 103, leaving of the entire image in the imaging apparatuses 101 through 103 can be avoided. It should be noted that storing a sampling matrix as related with the identifier of the server 200 allows the execution of restoring processing without increasing the data to be transmitted from the imaging apparatuses 101 through 103 to the server 200.

### 3. THIRD EMBODIMENT

In the first and second embodiments described above, it is presumed that compressive sensing restoration is executed on a combined image generated after combining a reference image with a changed area image; however, a reference image and a changed area image may also be separately restored. In this third embodiment, compressive sensing restoration is executed every time the server 200 receives an image. It should be noted that, since the overall configuration of the image transmission and reception system and the functional configuration of the imaging apparatus 100 are similar to those in the first embodiment described above, a detailed description thereof will be omitted.

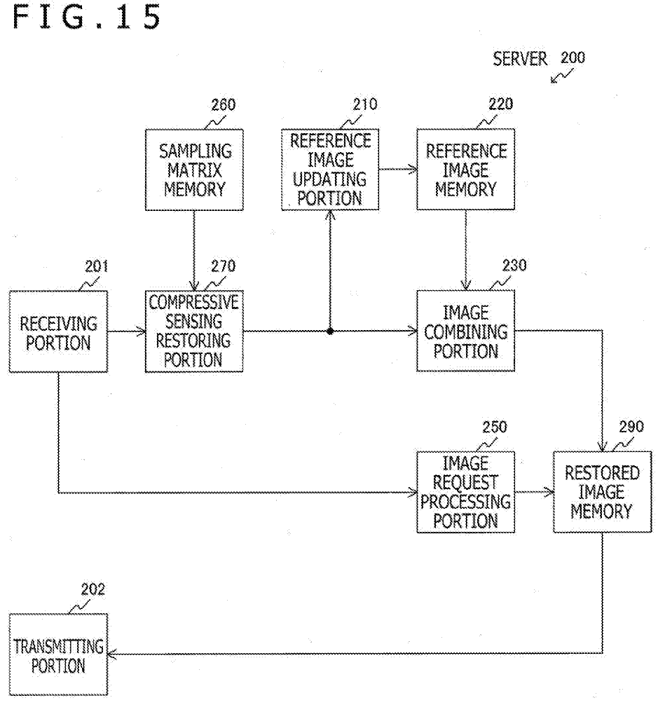

FIG. 15 is a diagram illustrating one example of a functional configuration of a server 200 in a third embodiment of the present technology. This server 200 has a receiving portion 201, a reference image updating portion 210, a reference image memory 220, an image combining portion 230, a sampling matrix memory 260, a compressive sensing restoring portion 270, an image request processing portion 250, a restored image memory 290, and a transmitting portion 202. The basic operation of each of these portions is similar to those in the first and second embodiments. However, the third embodiment is different from the first and second embodiments in that compressive sensing restoration is executed on each of the reference image and the changed area image received by the compressive sensing restoring portion 270 from the imaging apparatus 100.

More specifically, when the receiving portion 201 receives a reference image, the compressive sensing restoring portion 270 executes compressive sensing restoration on the received reference image. Then, the restored reference image is stored in the reference image memory 220 by the reference image updating portion 210. Further, when the receiving portion 201 receives a changed area image, the compressive sensing restoring portion 270 executes compressive sensing restoration on the received changed area image. Then, the restored changed area image is combined with the reference image by the image combining portion 230 and then stored in the restored image memory 290 as a restored image.

The restored image stored in the restored image memory 290 is transmitted by the image request processing portion 250 from the transmitting portion 202 when the receiving portion 201 receives an image request. Also, the restored image may be transmitted every time the receiving portion 201 receives a changed area image.

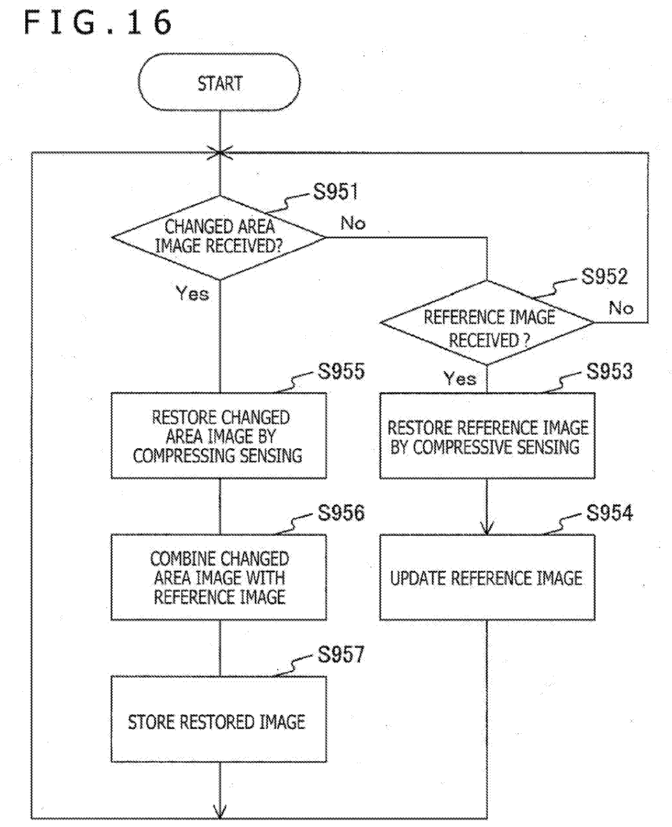

FIG. 16 is a flowchart indicative of an example of a processing procedure to be executed at the time of receiving an image of the server 200 in the third embodiment of the present technology.

When the receiving portion 201 receives a compressed image signal in the server 200 and, if the received compressed image signal is indicative of the entirety of this compressed image signal (step S951: No, S952: Yes), then compressive sensing restoration is executed with this compressed image signal as a reference image (step S953). Then, the reference image memory 220 is updated by this restored reference signal (step S954).

Meanwhile, when the receiving portion 201 receives a compressed image signal, if the received compressed image signal is a changed area image (step S951: Yes), compressive sensing restoration is executed on this changed area image (step S955). Then, the image combining portion 230 combines this restored changed area image with the reference image stored in the reference image memory 220 (step S956). This combined image is stored in the restored image memory 290 as a restored image (step S957).

As described above, according to the third embodiment of the present technology, compressive sensing restoration can be executed without waiting for the combining of a reference image and a changed area image.

### 4. APPLICATION EXAMPLES

The technology according to the present disclosure is so-called IoT (Internet of things) that is “the Internet of things.” IoT is a mechanism in which IoT devices 9001 that are “things” are connected to other IoT devices 9003, the Internet, the cloud 9005, and so on, to execute information exchange for mutual control. IoT can be used in a variety of industries including agriculture, housing, automobile, manufacturing, distribution, and energy.

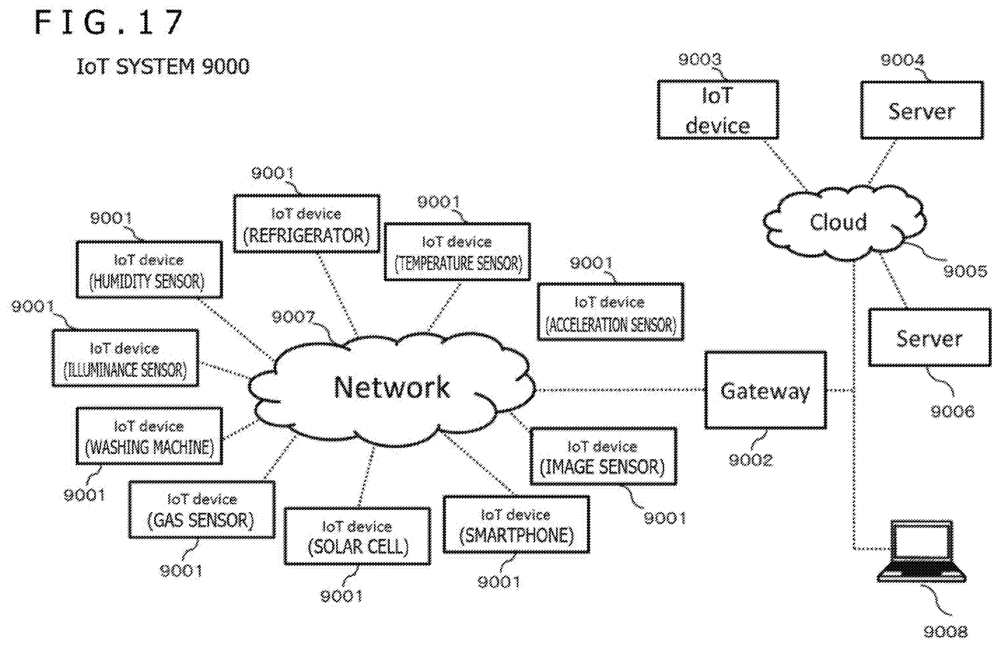

FIG. 17 is a diagram illustrating an example of a schematic configuration of an IoT system 9000 to which the technology according to an embodiment of the present disclosure is applicable.

The IoT devices 9001 include a variety of sensors such as temperature, humidity, illuminance, acceleration, distance, image, gas, and human sensors. Further, the IoT devices 9001 may additionally include terminals such as a smartphone, a mobile phone, a wearable terminal, and a gaming device. The IoT devices 9001 are powered, for example, by an alternating current (AC) power supply, a direct current (DC) power supply, a battery, a non-contact power supply, energy harvesting or the like. The IoT devices 9001 are capable, for example, of wired, wireless, and short-range wireless communication. Communication schemes suitably used are third-generation (3G)/LTE (registered trademark), wireless fidelity (Wi-Fi) (registered trademark), institute of electrical and electronic engineers (IEEE) 802.15.4, Bluetooth (registered trademark), Zigbee (registered trademark), and Z-Wave. The IoT devices 9001 may switch between the plurality of these communication sections to achieve communication.

The IoT devices 9001 may form one-to-one, star, tree, and mesh networks. The IoT devices 9001 may connect to the external cloud 9005 directly or via a gateway 9002. An address is assigned to each of the IoT devices 9001, for example, by internet protocol version (IPv) 4, IPv6, or IPv6 over low power wireless personal area networks (6LowPAN). Data collected from the IoT devices 9001 is transmitted to the other IoT device 9003, a server 9004, the cloud 9005, and so on. The timings and frequency for transmitted data from the IoT devices 9001 may be suitably adjusted for transmission of data in a compressed form. Such data may be used in an ‘as-is’ manner or analyzed by a computer 9008 by various sections such as statistical analysis, machine learning, data mining, cluster analysis, discriminant analysis, combinational analysis, and chronological analysis.

Such use of data enables provision of numerous services including control, warning, monitoring, visualization, automation, and optimization.

The technology according to an embodiment of the present disclosure is also applicable to home-related devices and services. The IoT devices 9001 in homes include washing machine, drying machine, dryer, microwave oven, dish washing machine, refrigerator, oven, electric rice cooker, cooking appliances, gas appliances, fire alarm, thermostat, air-conditioner, television (TV) set, recorder, audio appliances, lighting appliances, electric water heater, hot water dispenser, vacuum cleaner, electric fan, air purifier, security camera, lock, door-shutter opener/closer, sprinkler, toilet, thermometer, weighing scale, sphygmomanometer and the like. Further, the IoT devices 9001 may include solar cell, fuel cell, storage battery, gas meter, electric power meter, and distribution panel.

A low power consumption communication scheme is desirable as a communication scheme for the IoT devices 9001 in homes. Further, the IoT devices 9001 may communicate by Wi-Fi indoors and by 3G/LTE (registered trademark) outdoors. An external server 9006 designed to control IoT devices may be provided on the cloud 9005 to control the IoT devices 9001. The IoT devices 9001 transmit data including statuses of home appliances, temperature, humidity, power consumption, and presence or absence of humans and animals indoors and outdoors. Data transmitted from the home appliances is accumulated in the external server 9006 via the cloud 9005. New services are made available based on such data. The IoT devices 9001 designed as described above can be controlled by voice using voice recognition technologies.

In addition, direct transmission of information from the home appliances to the TV set permits visualization of the statuses of the home appliances. Further, determination of whether or not the resident is at home and transmission of data to air-conditioners and lighting appliances by various sensors makes it possible to turn the power thereof on and off. Still further, advertisements can be shown on the displays provided to various home appliances via the Internet.

As described above, one example of the IoT system 9000 to which the technology related with the present disclosure is applicable has been described. Of the configurations described above, the technology related with the present disclosure is suitably applicable to an image sensor.

It should be noted that the embodiments described above are indicative of only examples of embodying the present technology and there is a correlation between the matter in the embodiments and the matter used to specify the invention in the scope of the claims. Likewise, there is a correlation between the matter used to specify the invention in the scope of the claims and the matter in the embodiments of the present technology having the same name as that of the matter used to specify the invention in the scope of the claims. However, the present technology is not limited to the embodiments and therefore can be embodied by providing various modifications to the embodiments without departing from the gist of the technology.

Further, the processing procedures described in the embodiments described above may be understood as a method having a sequence of these procedures or a program for causing a computer to execute a sequence of these procedures or a recording medium for storing this program. For this recording media, a CD (Compact Disc), an MD (MiniDisc), a DVD (Digital Versatile Disc), a memory card, a Blu-ray Disc (Blu-ray (registered trademark) Disc), and the like, for example are available.

It should be noted that the effects recited in the present specification are illustrative only and therefore are not to be limitative, and other effects are possible.

It should also be noted that the present technology may adopt following configurations.

(1) An image transmission and reception system including:

an imaging apparatus photoelectrically converting part of pixels randomly selected from a plurality of pixels corresponding to light from a subject and transmitting the photoelectrically converted pixels as compressed image signals in a time sequence; and

a server receiving the compressed image signals via a network and restoring the compressed image signal on the basis of a sampling matrix for specifying the selection.

(2) The image transmission and reception system according to (1) described above, in which the server includes a sampling matrix memory storing the sampling matrix.

(3) The image transmission and reception system according to (2) described above, in which, before executing the restoration, the server receives the sampling matrix from the imaging apparatus via the network and stores the received sampling matrix into the sampling matrix memory.

(4) The image transmission and reception system according to any of (1) through (3) described above, in which the imaging apparatus detects an area in which luminance has changed as time passes with respect to the compressed image signals and transmits the area in which the change of the luminance of the compressed image signals has been detected to the server as an area signal.

(5) The image transmission and reception system according to (4) described above, in which the server includes
a reference image memory storing a reference image serving as a background of an image of the area signal,
an image combining portion combining an image of the area signal transmitted from the imaging apparatus with the reference image to generate a combined image,
an event sensing processing portion sensing occurrence of an event in the combined image, and
a restored image memory storing an image of the combined image after executing the restoration in accordance with a result of the sensing of the event.

(6) The image transmission and reception system according to (5) described above, in which the event sensing processing portion refers to the image of the combined image after executing the restoration to sense occurrence of the event.

(7) The image transmission and reception system according to (5) described above, in which the event sensing processing portion refers to an image of the combined image before executing the restoration to sense occurrence of the event.

(8) The image transmission and reception system according to (2) described above, in which the server stores the sampling matrix relating with a predetermined identifier in the sampling matrix memory, and upon reception of an image request along with the identifier from a terminal via the network, restores the compressed image signals on the basis of the sampling matrix stored in the sampling matrix memory as related with the received identifier to transmit the restored compressed image signals to the terminal.

(9) The image transmission and reception system according to (8) described above, in which the server executes transmission to the terminal only when the restoration is successful.

(10) A server including:

a receiving portion receiving, via a network, compressed image signals photoelectrically converted for part of pixels randomly selected from a plurality of pixels corresponding to light from a subject in accordance with a predetermined sampling matrix; and

a restoring portion restoring the compressed image signals on the basis of the sampling matrix.

(11) An imaging apparatus including:

an imaging portion photoelectrically converting part of pixels randomly selected from a plurality of pixels corresponding to light from a subject to output photoelectrically converted pixels as compressed image signals in a time sequence;

a change detecting portion detecting an area in which luminance has changed in accordance with lapse of time with respect to the compressed image signals; and

a transmitting portion transmitting, to a server, the area in which the change of the luminance of the compressed image signals has been detected.

### REFERENCE SIGNS LIST

100 through 103 Imaging apparatuses
110 Imaging portion
130 Change detecting portion
140 Transmitting portion
170 Frame memory
180 Timer
200 Server
201 Receiving portion
202 Transmitting portion
210 Reference image updating portion
220 Reference image memory
230 Image combining portion
240 Combined image memory
250 Image request processing portion
260 Sampling matrix memory
270 Compressive sensing restoring portion
280 Event sensing portion
290 Restored image memory
300 through 303 Terminals
400 Network
9001 IoT device

1. An image transmission and reception system comprising:
an imaging apparatus photoelectrically converting part of pixels randomly selected from a plurality of pixels corresponding to light from a subject and transmitting the photoelectrically converted pixels as compressed image signals in a time sequence; and
a server receiving the compressed image signals via a network and restoring the compressed image signal on a basis of a sampling matrix for specifying the selection.

2. The image transmission and reception system according to claim 1, wherein the server includes a sampling matrix memory storing the sampling matrix.

3. The image transmission and reception system according to claim 2, wherein, before executing the restoration, the server receives the sampling matrix from the imaging apparatus via the network and stores the received sampling matrix into the sampling matrix memory.

4. The image transmission and reception system according to claim 1, wherein the imaging apparatus detects an area in which luminance has changed as time passes with respect to the compressed image signals and transmits the area in which the change of the luminance of the compressed image signals has been detected to the server as an area signal.

5. The image transmission and reception system according to claim 4, wherein the server includes
a reference image memory storing a reference image serving as a background of an image of the area signal,
an image combining portion combining an image of the area signal transmitted from the imaging apparatus with the reference image to generate a combined image,
an event sensing processing portion sensing occurrence of an event in the combined image, and
a restored image memory storing an image of the combined image after executing the restoration in accordance with a result of the sensing of the event.

6. The image transmission and reception system according to claim 5, wherein the event sensing processing portion refers to the image of the combined image after executing the restoration to sense occurrence of the event.

7. The image transmission and reception system according to claim 5, wherein the event sensing processing portion refers to an image of the combined image before executing the restoration to sense occurrence of the event.

8. The image transmission and reception system according to claim 2, wherein the server stores the sampling matrix relating with a predetermined identifier in the sampling matrix memory, and upon reception of an image request along with the identifier from a terminal via the network, restores the compressed image signals on a basis of the sampling matrix stored in the sampling matrix memory as related with the received identifier to transmit the restored compressed image signals to the terminal.

9. The image transmission and reception system according to claim 8, wherein the server executes transmission to the terminal only when the restoration is successful.

10. A server comprising:
a receiving portion receiving, via a network, compressed image signals photoelectrically converted for part of pixels randomly selected from a plurality of pixels corresponding to light from a subject in accordance with a predetermined sampling matrix; and
a restoring portion restoring the compressed image signals on a basis of the sampling matrix.

11. An imaging apparatus comprising:
an imaging portion photoelectrically converting part of pixels randomly selected from a plurality of pixels corresponding to light from a subject to output photoelectrically converted pixels as compressed image signals in a time sequence;
a change detecting portion detecting an area in which luminance has changed in accordance with lapse of time with respect to the compressed image signals; and
a transmitting portion transmitting, to a server, the area in which the change of the luminance of the compressed image signals has been detected.
